(19) United States
(12) Patent Application Publication
(10) Pub. No.: US 2025/0172697 A1
(43) Pub. Date: May 29, 2025

(54) DISPLACEMENT INFORMATION OUTPUT DEVICE, DISPLACEMENT MEASUREMENT DEVICE, AND MOTION INFORMATION OUTPUT APPARATUS

(71) Applicants: Suguru SANGU, Kanagawa (JP); Takeshi MATSUO, Kanagawa (JP); Yuki ABE, Kanagawa (JP)

(72) Inventors: Suguru SANGU, Kanagawa (JP); Takeshi MATSUO, Kanagawa (JP); Yuki ABE, Kanagawa (JP)

(21) Appl. No.: 18/945,630

(22) Filed: Nov. 13, 2024

(30) Foreign Application Priority Data
Nov. 27, 2023 (JP) 2023-199711
Jul. 31, 2024 (JP) 2024-124846

(51) Int. Cl. G01S 17/66; G01S 7/481; G01S 7/4863

(52) U.S. Cl. CPC G01S 17/66; G01S 7/4814; G01S 7/4863

(57) ABSTRACT

A displacement information output device includes a light source to emit light to an object; a light guide member, and a light receiver. The light guide member includes a light incident portion from which the light subjected to at least one of reflection or scattering from the object is incident; and a light emitting portion from which the light guided through the light guide member is emitted. The light receiver receives the light emitted from the light emitting portion; and outputs information related to a three-dimensional displacement of the object obtained based on the emitted light.

### CROSS-REFERENCE TO RELATED APPLICATIONS

This patent application is based on and claims priority pursuant to 35 U.S.C. § 119(a) to Japanese Patent Application No. 2023-199711, filed on Nov. 27, 2023 and Japanese Patent Application No. 2024-124846, filed on Jul. 31, 2024, in the Japan Patent Office, the entire disclosure of which is hereby incorporated by reference herein.

### BACKGROUND

### Technical Field

The present disclosure relates to a displacement information output device, a displacement measurement device, and a motion information output apparatus.

### Related Art

A known displacement information output device irradiates an object with light and outputs information relating to a displacement of the object based on at least one of reflected light and scattered light from the object.

A disclosed example of a displacement information output device compares multiple speckle images with scaled images of the multiple speckle images to output information relating to a three-dimensional displacement of an object.

### SUMMARY

An embodiment of the present disclosure provides a displacement information output device includes a light source to emit light to an object; a light guide member, and a light receiver. The light guide member includes a light incident portion from which the light subjected to at least one of reflection or scattering from the object is incident; and a light emitting portion from which the light guided through the light guide member is emitted. The light receiver receives the light emitted from the light emitting portion; and outputs information related to a three-dimensional displacement of the object obtained based on the emitted light.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic top view of a displacement measurement device according to a first embodiment of the disclosure;

FIG. 2 is a schematic sectional view taken along line II-II in FIG. 1;

FIG. 3 is a schematic perspective view of the displacement measurement device according to the first embodiment of the disclosure;

FIG. 4 is a schematic perspective view of a displacement measurement device according to a second embodiment of the disclosure;

FIG. 5 is a schematic perspective view of a displacement measurement device according to a third embodiment of the disclosure;

FIG. 6 is a schematic perspective view of a displacement measurement device according to a fourth embodiment of the disclosure;

FIG. 7 is a schematic perspective view of a motion information output apparatus according to a fifth embodiment of the disclosure;

FIG. 8 is a schematic perspective view of a motion information output apparatus according to a sixth embodiment of the disclosure; and

FIG. 9 is a schematic perspective view of a motion information output apparatus according to a seventh embodiment of the disclosure.

FIG. 10 is a cross-sectional view of a displacement measurement device according to an eighth embodiment of the disclosure;

FIGS. 11A and 11B are diagrams each illustrating an example of the path of rays and a speckle image by simulation;

FIGS. 12A and 12B are diagrams each illustrating an example of the path of rays and a speckle image by simulation;

FIG. 13 is a schematic top view of a light guide member according to a first modification;

FIG. 14 is a schematic top view of a light guide member according to a second modification;

FIG. 15 is a schematic top view of a light guide member according to a third modification;

FIG. 16 is a schematic top view of a light guide member according to a fourth modification;

FIG. 17 is a schematic exploded perspective view of a light guide member according to a fifth modification;

FIG. 18 is a schematic exploded perspective view of a light guide member according to a sixth modification;

FIG. 19 is a schematic top view of a light guide member according to a seventh modification;

FIG. 20 is a schematic top view of a light guide member according to an eighth modification;

FIG. 21 is a schematic top view of a light guide member according to a ninth modification;

FIG. 22 is a schematic top view of a light guide member according to a tenth modification;

FIG. 23 is a schematic top view of a light guide member according to an eleventh modification;

FIG. 24 is a schematic top view of a light guide member according to a twelfth modification;

FIG. 25 is a schematic top view of a light guide member according to a thirteenth modification;

FIG. 26 is a schematic cross-sectional view taken along line XXVI-XXVI in FIG. 25;

FIG. 27 is a schematic top view of a light guide member according to a fourteenth modification;

FIG. 28 is a schematic cross-sectional view taken along line XXVIII-XIP in FIG. 27;

FIG. 29 is a schematic top view of a light guide member according to a fifteenth modification; and

FIG. 30 is a schematic cross-sectional view taken along the line XXX-XXX in FIG. 29.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With the embodiments of the present disclosure, the displacement information output device with high accuracy can be provided.

A displacement information output device, a displacement measurement device, and a motion information output apparatus according to embodiments of the disclosure are described in detail with reference to the drawings. However, the embodiments described below are illustrative of a displacement information output device, a displacement measurement device, and a motion information output apparatus for embodying the technical ideas of the embodiments of the disclosure, and the disclosure is not limited to the embodiments described below.

The dimensions, materials, shapes, relative arrangements, and so forth, of components described in the embodiments of the disclosure are not intended to limit the scope of the embodiments of the disclosure thereto, and are intended to be examples unless otherwise specifically indicated. The sizes, positional relationship, and so forth, of members illustrated in the drawings may be exaggerated for clarity of description. In the following description, identical names and reference signs represent identical or equivalent members, and detailed description thereof is appropriately omitted.

Hereinafter, an arrangement and a configuration of each component are described using an XYZ orthogonal coordinate system for easier understanding of the description. The X-axis, the Y-axis, and the Z-axis are orthogonal to one another. A direction in which the X-axis extends is referred to as an “X direction”, a direction in which the Y-axis extends is referred to as a “Y direction”, and a direction in which the Z-axis extends is referred to as a “Z direction”. A direction in which the arrow indicating the X-axis is headed is referred to as a +X direction or a +X side, and a direction opposite to the +X direction is referred to as a −X direction or a −X side. A direction in which the arrow indicating the Y-axis is headed is referred to as a +Y direction or a +Y side, and a direction opposite to the +Y direction is referred to as a −Y direction or a −Y side. A direction in which the arrow indicating the Z-axis is headed is referred to as a +Z direction or a +Z side, and a direction opposite to the +Z direction is referred to as a −Z direction or a −Z side. In this specification, as an example, it is assumed that an object is located on the +Z side of a light guide member included in a displacement information output device according to the embodiments of the disclosure. In this specification, the +Z direction is referred to as “upward” and the −Z direction is referred to as “downward”. However, these merely describe the relationship of relative positions, orientations, directions, and so forth, and may not match the relationship in practical use. These directions are irrelevant to the direction of gravity.

### First Embodiment

### Configuration of Displacement Measuring Device According to First Embodiment of the Invention

### Overall Configuration

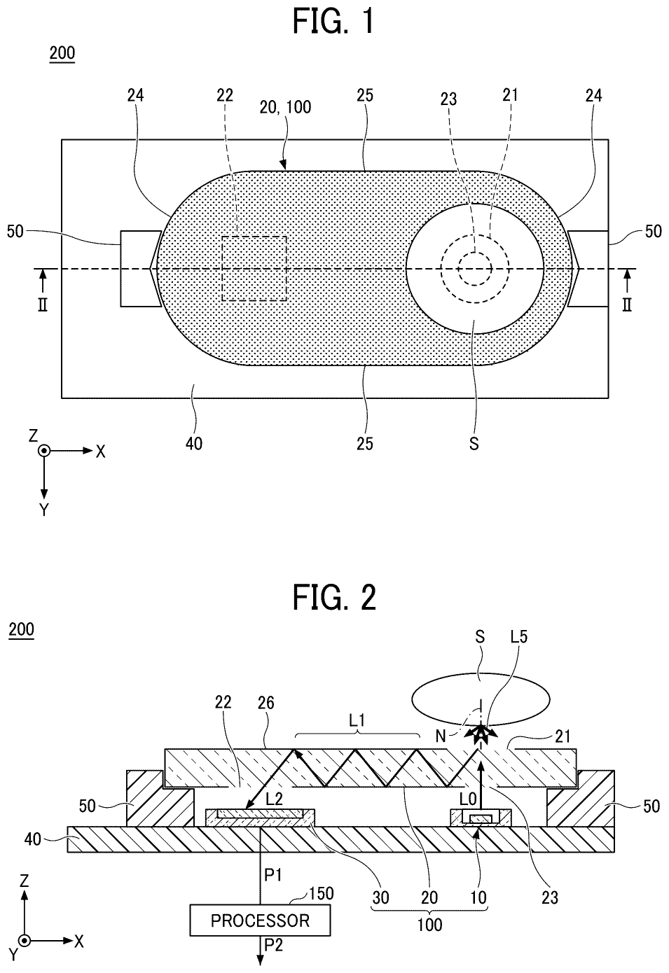

A displacement measurement device according to a first embodiment of the disclosure is described referring to FIGS. 1 to 3.

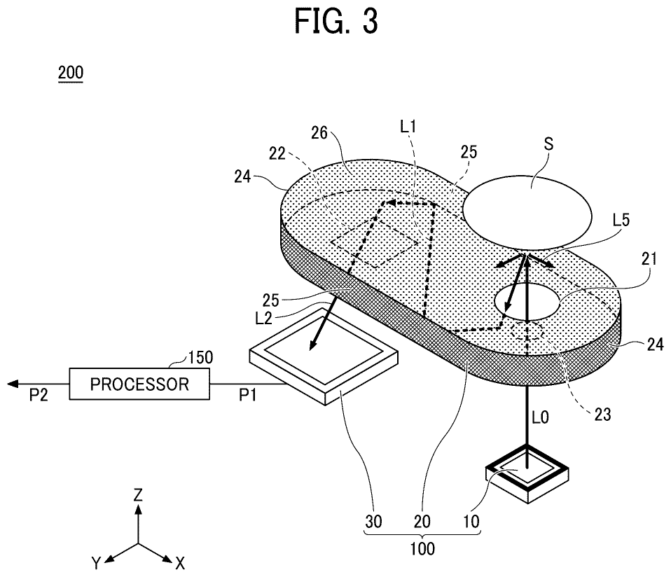

FIG. 1 is a schematic top view illustrating an example of a displacement measurement device 200 according to the first embodiment of the disclosure. FIG. 2 is a schematic sectional view taken along line II-II in FIG. 1. FIG. 3 is a schematic perspective view illustrating an example of the displacement measurement device 200 according to the first embodiment of the disclosure.

As illustrated in FIGS. 1 to 3, the displacement measurement device 200 includes a displacement information output device 100 and a processor 150. The processor 150 outputs a measurement result P2 of a three-dimensional displacement of an object S obtained based on information P1 relating to a three-dimensional displacement input from the displacement information output device 100. The object S is a measurement target of the displacement measurement device 200 from the viewpoint of measuring three-dimensional displacement. The displacement information output device 100 includes a light source 10. The displacement information output device 100 also includes a light guide member 20 including a light incident portion 21 and a light emitting portion 22. The light source 10 irradiates the object S with light L0. The light L0 is subjected to at least one of reflection and scattering at the object S. Then, the light guide member 20 guides light L1 incident from the light incident portion 21 and emits the light L1 from the light emitting portion 22. The displacement information output device 100 further includes a light receiver 30 that receives emitted light L2 from the light emitting portion 22 and outputs information relating to a three-dimensional displacement of the object S obtained based on the emitted light L2. In the example illustrated in FIGS. 1 and 2, the displacement information output device 100 includes a substrate 40 on which the light source 10 and the light receiver 30 are disposed, and a support 50 that supports the light guide member 20. In FIGS. 2 and 3, portions of the light L0, the light L1, and the emitted light L2 are indicated by arrows.

In the example illustrated in FIGS. 1 to 3, the emitted light L2 from the light emitting portion 22 includes speckles generated due to at least one of reflection and scattering at the object S. The light receiver 30 outputs information relating to a three-dimensional displacement of the object S obtained based on the speckles.

In the example illustrated in FIGS. 1 to 3, the light source 10 is disposed on the side opposite to the side on which the object S is located with respect to the light guide member 20. The light L0 emitted from the light source 10 is incident in the light guide member 20 through a light-source-side opening 23. The light L0 incident in the light guide member 20 passes through the inside of the light guide member 20, then is emitted from the light guide member 20 through the light incident portion 21, and irradiates the object S. The object S is, for example, a portion of a living body, such as a finger of a user who uses the displacement information output device 100. The object S reflects and scatters the light L0 irradiated from the light source 10 through the light guide member 20. The reflection by the object S includes regular reflection and diffuse reflection. The light L0 from the light source 10 is coherent light with high coherence. Portions of light L5 subjected to at least one of reflection and scattering in the region of the object S irradiated with the light L0 interfere with each other and hence generate speckles with a dot pattern having random brightness and darkness.

A portion of the light including the speckles generated due to the light L5 subjected to at least one of reflection and scattering at the object S is incident in the light guide member 20 through the light incident portion 21 of the light guide member 20. The light L1 incident in the light guide member 20 is guided in the light guide member 20 while being reflected by each of surfaces defining the light guide member 20. A portion of the light L1 that has reached the light emitting portion 22 of the light guide member 20 included in the light L1 guided in the light guide member 20 is emitted through the light emitting portion 22.

The emitted light L2 emitted from the light emitting portion 22 includes the speckles generated due to the light L5 subjected to at least one of reflection and scattering at the object S. The light receiver 30 can receive at least a portion of the emitted light L2.

The state of the speckles, such as the position and shape of the dot pattern, changes in accordance with a three-dimensional displacement of the object S. The light receiver 30 receives the emitted light L2 including the speckles to output information P1 relating to a three-dimensional displacement of the object S based on the speckles.

The information P1 relating to the three-dimensional displacement of the object S output from the light receiver 30 is input to the processor 150. The processor 150 acquires a measurement result P2 of a three-dimensional displacement of the object S by computation based on the information P1 relating to the three-dimensional displacement of the object S input from the light receiver 30, and outputs the measurement result P2 to an external device. Examples of the external device to which the displacement measurement device 200 outputs the measurement result P2 include an information processing device such as a personal computer (PC), a display device such as a liquid crystal display, and a storage device such as a hard disk drive (HDD).

In FIG. 2, when the object S is displaced in a plane substantially orthogonal to the normal line N of the region of the object S irradiated with the light L0, for example, in a plane along an XY plane in FIGS. 1 to 3, the position of the speckles mainly changes in accordance with the in-plane displacement. The displacement information output device can acquire information relating to the in-plane displacement of the object S in accordance with the change in position of the speckles. In contrast, when the object S is displaced out of a plane in a direction along the normal line N of the region of the object S, for example, in a direction in the Z direction in FIGS. 1 to 3, a change in shape such as the size of the speckles is more dominant than a change in position of the speckles. For example, since a change in shape of the speckles is dominant, the amount of change in state of the speckles corresponding to the out-of-plane displacement may be smaller than the amount of change in state of the speckles according to the in-plane displacement. In other words, the sensitivity of information relating to the out-of-plane displacement of the object S according to the change in state of the speckles is lowered. Since the sensitivity is lowered, the displacement information output device may no longer highly accurately acquire the information relating to the three-dimensional displacement of the object S including the in-plane displacement and the out-of-plane displacement.

In the present embodiment, since the light L1 including the speckles is guided in the light guide member 20, the light L1 can propagate for a long distance as compared to a case where the light is not guided by the light guide member 20. Since the light L1 propagates for a long distance, the amount of change in state of the speckles included in the emitted light L2 from the light emitting portion 22 increases. Since the amount of change in state of the speckles increases, the sensitivity of the information P1 relating to the three-dimensional displacement of the object S according to the change in state of the speckles increases. Since the sensitivity of the information P1 relating to the three-dimensional displacement of the object S increases, the displacement information output device 100 can output the information P1 relating to the three-dimensional displacement of the object S with high accuracy. In other words, according to this embodiment, the displacement information output device 100 with high accuracy can be provided. Moreover, the displacement measurement device 200 acquires the measurement result P2 of the three-dimensional displacement of the object S by computation based on the information P1 relating to the three-dimensional displacement of the object S with high accuracy input from the displacement information output device 100. Thus, the displacement measurement device 200 can acquire the measurement result P2 with high accuracy and output the measurement result P2 to the external device.

The emitted light L2 does not have to be the light including the speckles generated due to at least one of reflection and scattering at the object S as long as the light L2 is the light subjected to at least one of reflection and scattering at the object S and guided by the light guide member 20. Even when the emitted light L2 does not include speckles, the displacement information output device 100 can acquire and output the information relating to the three-dimensional displacement of the object S with high accuracy as compared to a case without the light guide member 20.

In the displacement information output device 100 illustrated in FIGS. 1 to 3, as described above, the light source 10 is disposed on the side opposite to the side on which the object S is located with respect to the light guide member 20. The light L0 emitted from the light source 10 irradiates the object S through the light guide member 20. Since the light source 10 is disposed on the side opposite to the object S with respect to the light guide member 20, the light source 10 can face the object S via the light guide member 20. Thus, the displacement information output device 100 can be downsized, the number of components included in the displacement information output device 100 can be reduced, and the configuration of the displacement information output device 100 can be simplified.

Hereinafter, the configurations of the displacement information output device 100 and the displacement measurement device 200 are described in detail.

### Light Source 10

When the displacement information output device 100 uses speckles, the light source 10 that emits light L0 with high coherence can be used. The light with high coherence in this specification represents light with higher coherence than the coherence of light emitted from a white light source or a light emitting diode (LED). From another viewpoint, the light with high coherence in this specification represents light having a coherence length larger than the coherence length of the light emitted from the white light source or the LED.

Examples of the light source that emits the light with higher coherence than the coherence of the light emitted from the white light source or the LED include a laser-beam source. Since the displacement information output device 100 includes the light source 10 that emits the light L0 with high coherence, the displacement information output device 100 can properly generate speckles generated due to the light L5 subjected to at least one of reflection and scattering at the object S. Accordingly, the displacement information output device 100 can properly acquire the information PI relating to the three-dimensional displacement of the object S using the speckles. When the displacement information output device 100 does not use speckles, the light source 10 does not have to emit the light L0 with high coherence.

From the viewpoint of downsizing the displacement information output device 100 and the displacement measurement device 200, the laser-beam source of the light source 10 may use a semiconductor laser (laser diode (LD)). The semiconductor laser may use a vertical cavity surface emitting laser (VCSEL).

When the VCSEL is used for the light source 10, it is desirable to use a package in which a light source chip is mounted in a package member, from the viewpoint of easier handling. However, the laser-beam source of the light source 10 is not limited to the VCSEL, and may be an edge emitting semiconductor laser. The light source 10 including the semiconductor laser emits light L0 in accordance with an electric current applied from a drive circuit or the like. The light L0 is light with high coherence, and hence is mainly monochromatic light.

### Light Guide Member 20

The light guide member 20 has a light-guiding part made of a light transmissive glass material, a light transmissive resin material, or an air gap. When the light-guiding part consists of an air gap, it is preferable to form a reflective surface and design the outer peripheral part with a flat plate structure to allow the light guide member to be self-supporting. The light guide member 20 desirably has light transmissivity of 60% or more for the peak wavelength of the light emitted from the light source 10.

The light guide member 20 illustrated in FIGS. 1 to 3 includes a light reflective member 26 covering surfaces of the light guide member 20. The light incident portion 21 is a first opening provided in the light reflective member 26. The light emitting portion 22 is a second opening provided in the light reflective member 26. The light reflective member 26 is provided on the entire surfaces of the light guide member 20 other than the light incident portion 21, the light emitting portion 22, and the light-source-side opening 23. From another viewpoint, each of the light incident portion 21, the light emitting portion 22, and the light-source-side opening 23 is a portion of the surfaces of the light guide member 20 not provided with the light reflective member 26. Alternatively, each of the light incident portion 21, the light emitting portion 22, and the light-source-side opening 23 are through-hole portions provided in the flat plate structure. The light reflective member 26 is, for example, a metal film of aluminum or the like. Since the light guide member 20 includes the light reflective member 26, the light L1 incident through the light incident portion 21 can be confined in the light guide member 20. The light guide member 20 can reflect the light L1 confined in the light guide member 20 by the light reflective member 26 to guide the light L1 and emit the light L1 from the light emitting portion 22.

The light guide member 20 totally reflects the light incident from the light incident portion in the light guide member to guide the light.

However, the light guide member 20 does not have to include the light reflective member 26. For example, the light guide member 20 can guide the light L1 from the light incident portion 21 by totally reflecting the light L1 in the light guide member 20. Portions having curvatures at both ends of the light guide member 20 reflect light in various directions, thereby generating light that does not satisfy the total reflection condition. The displacement information output device 100 can extract a portion of light, which leaks from the portions having the curvatures at both ends, from the light guide member 20. When the light L1 is guided by total internal reflection, the displacement information output device 100 does not have to include the light reflective member 26 provided on the surfaces of the light guide member 20, thereby simplifying the configuration of the light guide member 20 and facilitating the manufacturing of the light guide member 20.

The light guide member 20 illustrated in FIGS. 1 to 3 is a member long in a predetermined longitudinal direction. The light guide member 20 has end portions on both sides of the light guide member 20 in the longitudinal direction. The end portions have curved surfaces 24. The light guide member 20 has linear portions 25 between the curved surfaces 24 on both sides of the light guide member 20 in the longitudinal direction. The linear portions 25 extend in the longitudinal direction when the light guide member 20 is viewed in a direction orthogonal to the longitudinal direction. The light guide member 20 having the curved surfaces 24 and the linear portions 25 can give nonlinearity to the distribution of light path lengths of the light L1 guided in the light guide member 20. By giving the nonlinearity to the distribution of the light path lengths of the light L1, the displacement information output device 100 can increase the sensitivity of the information P1 relating to the three-dimensional displacement of the object S.

In the example illustrated in FIGS. 1 to 3, the longitudinal direction is the X direction. The light guide member 20 is a member long in the X direction. The curved surfaces 24 are semicircular or hemicylindrical curved surfaces in top view. The linear portions 25 are provided on both sides of the light guide member 20 in the direction orthogonal to the longitudinal direction, for example, the Y direction in top view. The light guide member 20 has an oval shape in top view, which can also be described as a stadium shape from another perspective. As described in “Kogaku” (Japanese Journal of Optics), vol. 37, no. 3, 2008, pp. 142 to 155, which is a comparative example, in a light guide member having an oval shape, the path of rays guided in the light guide member exhibits nonlinearity (chaos). The displacement information output device 100 uses the nonlinearity of the path of rays to acquire the information P1 relating to the three-dimensional displacement of the object S with high sensitivity. As described in the above-described comparative example, the path of rays guided in the light guide member exhibits irregular density. The irregular density represents that the light path lengths of rays to be guided are widely distributed from large lengths to small lengths. The path of rays to be guided can be analyzed using a diagram called a Poincare transverse diagram.

In the displacement information output device 100, the configuration of the light guide member 20 is determined so that a closed curve structure does not appear in the Poincare transverse diagram. Thus, a characteristic mode can be eliminated in the path of the light L1 guided by the light guide member 20. Since the characteristic mode is eliminated, the propagation distance of the light L1 in the light guide member 20 can be increased, and the light L1 can reach the light emitting portion 22 of the light guide member 20 with a high probability. Consequently, the displacement information output device 100 can obtain the information P1 relating to the three-dimensional displacement of the object S with high sensitivity for the displacement of the object S in the out-of-plane direction.

The light guide member 20 illustrated in FIG. 1 is a plate-shaped member. Since the light guide member 20 is the plate-shaped member, the displacement information output device 100 can be reduced in thickness. The reduction in thickness of the displacement information output device 100 represents a reduction in length of the displacement information output device 100 in the thickness direction of the light guide member 20 that is the plate-shaped member.

The light guide member 20 may include a laser medium that amplifies the light L1 guided in the light guide member 20. Examples of the laser medium included in the light guide member 20 include gallium arsenide (GaAs), indium gallium arsenide (InGaAs), and gallium nitride (GaN). Since the light guide member 20 includes the laser medium, the light L1 guided in the light guide member 20 can be amplified by an amplification function of the laser medium. Amplifying the light L1 can increase the signal to noise ratio (SNR) of the information PI relating to the three-dimensional displacement of the object S obtained by the light receiver 30 receiving the emitted light L2 from the light guide member 20. Moreover, the amplification function has an effect of further extending the light path length. By increasing the SNR of the information P1 relating to the three-dimensional displacement of the object S, the displacement information output device 100 can acquire the information P1 relating to the three-dimensional displacement of the object S with high accuracy.

The shape of the light-source-side opening 23 is desirably a substantially circular shape to meet the sectional shape substantially orthogonal to the center axis of the light L0 (light beam) emitted from the light source 10. However, the shape of the light-source-side opening 23 is not limited to the substantially circular shape, and may be a substantially rectangular shape, a substantially elliptical shape, a substantially polygonal shape, or the like. To allow the light L0 from the light source 10 to be incident as much as possible and to reduce a loss due to diffraction at the opening, the diameter of the light-source-side opening 23 is desirably 1.5 times or more and 2.0 times or less the diameter of the light L0 emitted from the light source 10. Alternatively, the opening area of the light-source-side opening 23 is desirably an opening area corresponding to 1.5 times or more and 2.0 times or less the diameter of the light L0 emitted from the light source 10.

The shape of the first opening serving as the light incident portion 21 is desirably a substantially circular shape to meet the sectional shape substantially orthogonal to the center axis of the light L0 emitted from the light source 10. However, the shape of the first opening is not limited to the substantially circular shape, and may be a substantially rectangular shape, a substantially elliptical shape, or a substantially polygonal shape. From the viewpoint to allow as much light propagating in an oblique direction as possible to be incident among the light L5 subjected to at least one of reflection and scattering at the object S, the opening area of the first opening is desirably two times or more and three times or less the area of the irradiation region with the light L0 on the object S.

The shape of the second opening serving as the light emitting portion 22 is desirably a substantially rectangular shape to meet the shape of a light receiving surface included in the light receiver 30. However, the shape of the second opening is not limited to the substantially rectangular shape, and may be a substantially circular shape, a substantially elliptical shape, or a substantially polygonal shape. The opening area of the second opening may be about the area of the light receiving surface included in the light receiver 30.

### Light Receiver 30

The light receiver 30 may use an image sensor that is a two-dimensional imaging element. To increase the speed of measurement by the displacement measurement device 200, a high-speed camera available for high-speed imaging may be used for the light receiver 30.

Alternatively, the light receiver 30 may include multiple pixels, detect a change in brightness of each of the multiple pixels, and output information relating to the change in brightness in combination with coordinate information and time information. Such a light receiver is referred to as an event-based vision sensor®. A signal output from the light receiver 30, which is the event-based vision sensor®, is an example of the information P1 relating to the three-dimensional displacement of the object S. Using the event-based vision sensor® for the light receiver 30, the information P1 relating to the three-dimensional displacement of the object S is output, for example, when an event such as a change in brightness occurs. Accordingly, the amount of information output from the light receiver 30 can be reduced, and the processing load of the processor 150 for computing the measurement result P2 of the three-dimensional displacement of the object S can be reduced. Reducing the amount of information output from the light receiver 30 and reducing the processing load of the processor 150 can increase the speed of measurement by the displacement measurement device 200. For example, the displacement information output device 100 uses the event-based vision sensor® for the light receiver 30 to perform high-speed measurement corresponding to 500 frames per second (fps) to 800 fps.

### Substrate 40

The substrate 40 is a mounting substrate on which at least the light source 10 and the light receiver 30 are disposed. The substrate 40 may use, for example, a printed circuit board in which wiring serving as a conductor is disposed on or in a plate-shaped member including an insulator. Electronic components other than the light source 10 and the light receiver 30 may be disposed on the substrate 40. For example, the processor 150 or a memory that is used in the processing performed by the processor 150 may be disposed on the substrate 40. From the viewpoint to make the inside of the displacement information output device 100 less visible and to reduce noise due to external light, the substrate 40 is desirably made of a material having light shielding characteristics or light absorbing characteristics for the wavelength of external light.

### Support 50

In the example illustrated in FIGS. 1 and 2, the support 50 is disposed on a surface of the substrate 40 on which the light source 10 and the light receiver 30 are disposed. Alternatively, the support 50 may be disposed on a surface of the substrate 40 opposite to the surface on which the light source 10 and the light receiver 30 are disposed. The light guide member 20 is secured to the support 50 with an adhesive member or the like. The support 50 can include a resin material or a metal material.

### Processor 150

As described above, the processor 150 can output the measurement result P2 of the three-dimensional displacement of the object S obtained based on the information P1 relating to the three-dimensional displacement input from the displacement information output device 100. The processor 150 includes, for example, a central processing unit (CPU). The functions of the processor 150 are implemented by the processor 150 executing processing prescribed in a program stored in a non-volatile memory, such as a read-only memory (ROM). A portion of the functions implemented by the processor 150 may be implemented by an application specific integrated circuit (ASIC), a digital signal processor (DSP), a field programmable gate array (FPGA), or the like.

Processing performed by the processor 150 is described. As described above, since the displacement information output device 100 includes the light guide member 20, the nonlinearity can be given to the distribution of the light path lengths of the light L1 guided in the light guide member 20. Since the nonlinearity is given, the relationship between the in-plane movement of the speckles and the in-plane displacement of the object S in the measurement method of related art using the speckles is no longer established. Thus, an analysis method corresponding to the nonlinearity given to the distribution of the light path lengths of the light L1 is used. The analysis method corresponding to the nonlinearity may use a displacement estimation method using machine learning performed by a computer. Alternatively, a method called physical reservoir computing that uses non-linear response characteristics of a device as an estimation engine can be used. The processor 150 can execute the analysis computation corresponding to such nonlinearity. At least a portion of the analysis computation corresponding to the nonlinearity may be performed by an external information processing device other than the processor 150.

### Second Embodiment

Next, a displacement measurement device according to a second embodiment of the disclosure is described. Identical names and reference signs as in the above-described embodiment represent identical or equivalent members or components, and detailed description thereof is appropriately omitted. This point is likewise applied to embodiments described later.

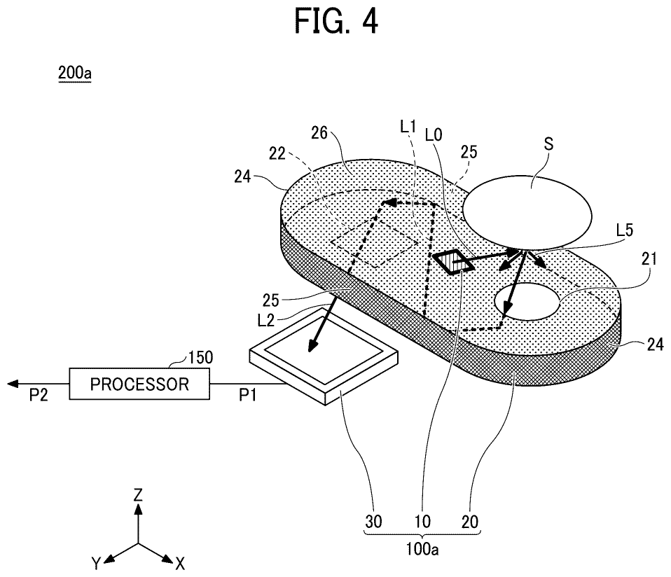

FIG. 4 is a schematic perspective view illustrating an example of a displacement measurement device 200a according to the second embodiment of the disclosure.

As illustrated in FIG. 4, the displacement measurement device 200a includes a displacement information output device 100a. In the displacement information output device 100a, the light source 10 is disposed on the side on which an object S is located with respect to the light guide member 20. The light L0 that is emitted from the light source 10 irradiates the object S without passing through the light guide member 20. These points are mainly different from those of the displacement information output device 100 according to the first embodiment of the disclosure. In FIG. 4, portions of the light L0, the light L1, and the emitted light L2 are indicated by arrows.

In the example illustrated in FIG. 4, the object S and the light source 10 are both disposed above the light guide member 20. The light source 10 may be disposed on a substrate different from the substrate 40 illustrated in FIG. 2.

The light L0 that is emitted from the light source 10 irradiates the object S without passing through the light guide member 20. A portion of the light L5 resulted from the light L0 subjected to at least one of reflection and scattering by the object S is incident in the light guide member 20 through the light incident portion 21. The light L1 incident on the light guide member 20 is guided in the light guide member 20, and then is emitted through the light emitting portion 22. The light receiver 30 receives the emitted light L2 from the light emitting portion 22, and outputs information P1 relating to a three-dimensional displacement of the object S obtained based on speckles included in the emitted light L2.

Since the light source 10 can be disposed on the side on which the object S is located with respect to the light guide member 20 in the displacement information output device 100a, members included in the displacement information output device 100a can be disposed with higher flexibility. Also in the displacement measurement device 200a, members included in the displacement measurement device 200a can be disposed with higher flexibility. Advantageous effects other than these points are similar to those of the first embodiment of the disclosure.

### Third Embodiment

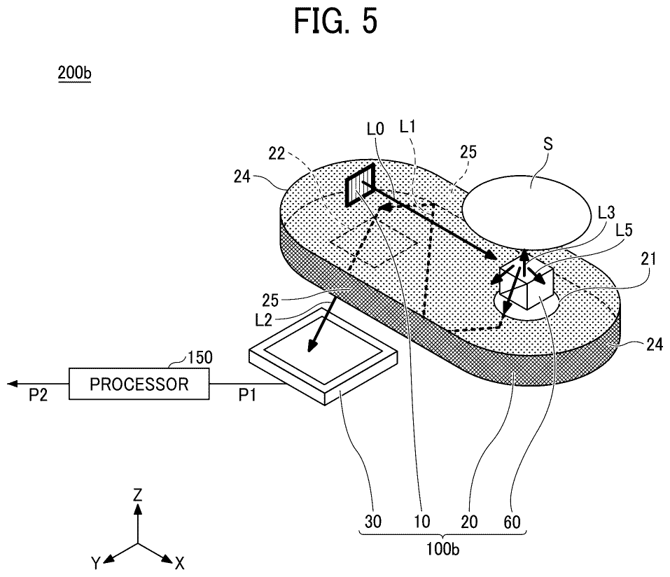

Next, a displacement measurement device according to a third embodiment of the disclosure is described. FIG. 5 is a schematic perspective view illustrating an example of a displacement measurement device 200b according to the third embodiment of the disclosure.

As illustrated in FIG. 5, the displacement measurement device 200b includes a displacement information output device 100b. The displacement information output device 100b includes a light deflecting member 60 (or a light deflector) disposed between an object S and the light guide member 20. The light L0 emitted from the light source 10 is incident on the light deflecting member 60. The light deflecting member 60 irradiates the object S with the light L0 incident from the light source 10. Light L3 irradiated from the light deflecting member 60 is subjected to at least one of reflection and scattering at the object S, and then the light guide member 20 guides the light L1 incident from the light incident portion 21. These points are mainly different from those of the displacement information output device 100 according to the first embodiment of the disclosure. In FIG. 5, portions of the light L0, the light L1, the emitted light L2, and the light L3 are indicated by arrows.

In the example illustrated in FIG. 5, the object S, the light source 10, and the light deflecting member 60 are disposed above the light guide member 20. The light deflecting member 60 can use a beam splitter, a half mirror, or the like. The light L0 emitted from the light source 10 is incident on the light deflecting member 60, and is deflected by the light deflecting member 60 toward the object S. The light L3 deflected toward the object S irradiates the object S without passing through the light guide member 20. A portion of the light L5 resulted from the light L3 subjected to at least one of reflection and scattering by the object S is incident in the light guide member 20 through each of the light deflecting member 60 and the light incident portion 21. The light L1 incident on the light guide member 20 is guided in the light guide member 20, and then is emitted through the light emitting portion 22. The light receiver 30 receives the emitted light L2 from the light emitting portion 22, and outputs information P1 relating to a three-dimensional displacement of the object S obtained based on speckles included in the emitted light L2.

For example, when the angle of the object S with respect to the light irradiated from the light source 10 changes in accordance with the type and state of the object S, the incidence efficiency of the light L5 subjected to at least one of reflection and scattering at the object S onto the light guide member 20 may be decreased. Since the displacement information output device 100b includes the light deflecting member 60 between the object S and the light guide member 20, the irradiation angle of the light L3 irradiating the object S from the light deflecting member 60 can be changed by changing the deflection angle by the light deflecting member 60. Accordingly, by adjusting the irradiation angle of the light L3 on the object S in accordance with the type and state of the object S, the displacement information output device 100b can reduce a decrease in incidence efficiency of the light L5 subjected to at least one of reflection and scattering by the object S on the light guide member 20, and acquire the information P1 relating to the three-dimensional displacement of the object S with high accuracy.

Since the light source 10 and the light deflecting member 60 are disposed in the longitudinal direction of the light guide member 20 in the displacement information output device 100b, the light path from the light source 10 to the light deflecting member 60 can be increased in length. Accordingly, a space to dispose various optical members such as a lens, a band-pass filter, and a polarization filter can be ensured in the light path from the light source 10 to the light deflecting member 60.

By controlling the wavefront state of the light L0 irradiating the object S using various optical members disposed in the light path from the light source 10 to the light deflecting member 60, the light L0 conforming to the type and state of the object S can irradiate the object S. Accordingly, a decrease in incidence efficiency of the light L5 subjected to at least one of reflection and scattering by the object S on the light guide member 20 can be reduced, and the information P1 relating to the three-dimensional displacement of the object S can be acquired with high accuracy.

The displacement measurement device 200b can also acquire a measurement result P2 of a three-dimensional displacement of the object S with high accuracy, similarly to the displacement information output device 100b.

Advantageous effects other than the above are similar to those in the first embodiment of the disclosure.

### Fourth Embodiment

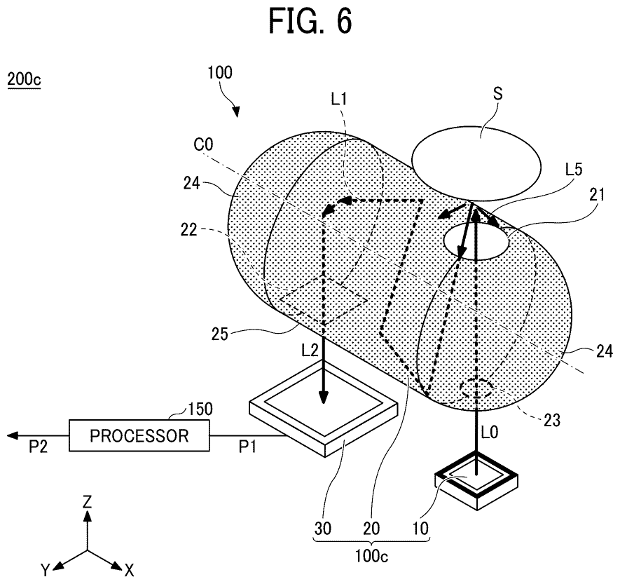

Next, a displacement measurement device according to a fourth embodiment of the disclosure is described. FIG. 6 is a schematic perspective view illustrating an example of a displacement measurement device 200c according to the fourth embodiment of the disclosure.

As illustrated in FIG. 6, the displacement measurement device 200c includes a displacement information output device 100c. The displacement information output device 100c differs from the displacement information output device 100 according to the first embodiment of the disclosure mainly in that the light guide member 20 is a member long in a predetermined longitudinal direction, and is a rotationally symmetrical body having a rotation axis that is a center axis C0 of the light guide member 20 extending in the longitudinal direction. In FIG. 6, portions of the light L0, the light L1, and the emitted light L2 are indicated by arrows.

In the example illustrated in FIG. 6, the light guide member 20 is a member long in the longitudinal direction, for example, the X direction. The light guide member 20 is the rotationally symmetrical body having the rotation axis that is the center axis C0 of the light guide member 20 extending in the longitudinal direction. The light guide member 20 has end portions on both sides in the longitudinal direction, the end portions having curved surfaces 24 when the light guide member 20 is viewed in any direction around the center axis C0 orthogonal to the longitudinal direction of the light guide member 20. Moreover, the light guide member 20 has linear portions 25 provided between the curved surfaces 24 on both sides of the light guide member 20 in the longitudinal direction and extending in the longitudinal direction when the light guide member 20 is viewed in any direction around the center axis C0 orthogonal to the longitudinal direction of the light guide member 20. The light guide member 20 has an oval shape when the light guide member 20 is viewed in any direction around the center axis C0 orthogonal to the longitudinal direction of the light guide member 20. From another viewpoint, the light guide member 20 has a so-called capsule shape.

Since the light guide member 20 has the capsule shape, the displacement information output device 100c can give nonlinearity to the distribution of light path lengths of the light L1 guided in the light guide member 20 in any direction around the center axis C0 of the light guide member 20. By giving the nonlinearity to the distribution of the light path lengths of the light L1, the displacement information output device 100c can increase the sensitivity of information P1 relating to a three-dimensional displacement of an object S for a displacement of the object S in an out-of-plane direction. Accordingly, the displacement information output device 100c can acquire the information P1 relating to the three-dimensional displacement of the object S with high accuracy. The displacement measurement device 200c can also obtain a measurement result P2 of a three-dimensional displacement of the object S with high accuracy similarly. Advantageous effects other than these points are similar to those of the first embodiment of the disclosure.

The light guide member 20 is not limited to a non-hollow member, such as the plate-shaped member described in the first embodiment or the capsule-shaped member described in the present embodiment, and may be a hollow member having a cavity portion inside. The light guide member 20 can guide light by reflecting light at an inner surface of the hollow member. The inner surface of the hollow member may be provided with a reflecting film. The reflecting film may be made of a metal material, such as gold, aluminum, or cobalt.

### Fifth Embodiment

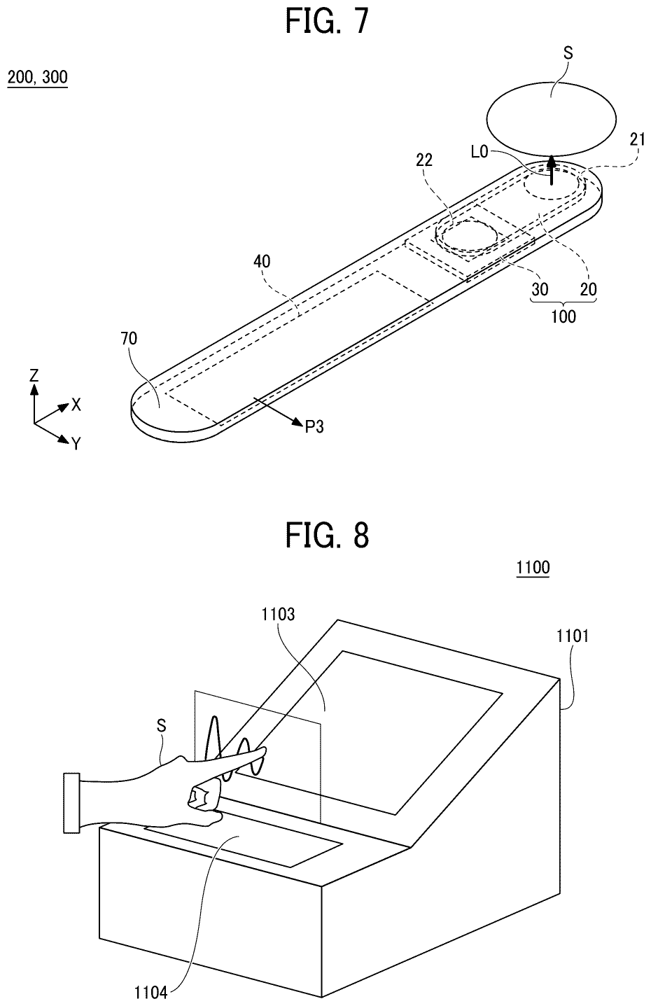

Next, a motion information output apparatus according to a fifth embodiment of the disclosure is described. FIG. 7 is a schematic perspective view of an example of a motion information output apparatus 300 according to the fifth embodiment of the disclosure.

As illustrated in FIG. 7, the motion information output apparatus 300 includes the displacement measurement device 200.

The displacement measurement device 200 includes the displacement information output device 100. In FIG. 7, the reference sign of the motion information output apparatus 300 and the reference sign of the displacement measurement device 200 are both presented to indicate that the motion information output apparatus 300 includes the displacement measurement device 200.

The motion information output apparatus 300 can output motion information P3 on an object S obtained based on a measurement result P2 of a three-dimensional displacement of the object S input from the displacement measurement device 200. The motion information P3 on the object S is information relating to a three-dimensional movement of the object S. For example, when the object S is a finger of a user, the motion information output apparatus 300 can acquire and output motion information P3 as information relating to a three-dimensional movement of the finger. The motion information P3 output from the motion information output apparatus 300 may be used for an operation input interface with a finger.

In the example illustrated in FIG. 7, the motion information output apparatus 300 is a handheld apparatus.

A housing 70 houses the displacement information output device 100, the substrate 40, a processor, and so forth. The housing 70 can include a resin material or a metal material. From the viewpoint to make the inside of the displacement information output device 100 less visible and to reduce noise due to external light, the housing 70 is desirably made of a material having light shielding characteristics or light absorbing characteristics for the wavelength of external light.

In the example illustrated in FIG. 7, the object S is located to face the light incident portion 21 of the light guide member 20 in the displacement information output device 100. The user can perform an operation input by moving the thumb or index finger near the light incident portion 21. The motion information output apparatus 300 is connected to an information processing device, such as a PC or a smartphone, wirelessly or by wire, and the motion information P3 is given from the motion information output apparatus 300 to the information processing device. The substrate 40 includes, for example, a communication device that is connected wirelessly or by wire, a power supply circuit, and a recognition processing circuit. The motion information output apparatus 300 can be naturally held in the palm of the user like a writing implement. Using the motion information output apparatus 300 can provide a natural operation input in a non-contact manner without restricting the movement of the user in an operation in a virtual reality (VR) space or an operation in a state wearing augmented reality (AR) glasses.

### Sixth Embodiment

Next, a motion information output apparatus according to a sixth embodiment of the disclosure is described. FIG. 8 is a schematic perspective view of an example of a motion information output apparatus 1100 according to the sixth embodiment of the disclosure.

As illustrated in FIG. 8, the motion information output apparatus 1100 includes a housing 1101, an image forming plate 1103, and an optical window 1104. The motion information output apparatus 1100 also includes the displacement measurement device 200 in the housing 1101.

In the motion information output apparatus 1100, the displacement measurement device 200 provides irradiation with coherent light as sheet light directed upward and forward of the housing 1101 (toward the vicinity of a virtual image that is formed by the image forming plate 1103). When an object S such as a finger of a user intersects the sheet light by a non-contact operation on the virtual image using the object S, reflected light or scattered light of the sheet light from the object S is incident as an interference image on the light receiver 30 included in the displacement measurement device 200 via the optical window 1104 and the light guide member 20 included in the displacement measurement device 200. Accordingly, the processor 150 included in the displacement measurement device 200 can acquire a measurement result of a three-dimensional displacement of the object S and output the measurement result to a non-contact input identification unit included in the motion information output apparatus 1100.

The non-contact input identification unit can detect a non-contact operation (for example, a pressing motion with a finger, a handwriting motion, or a swipe motion) performed by the object S with high accuracy based on the measurement result of the three-dimensional displacement of the object S input from the displacement measurement device 200, and output the detection result to a device to be operated or feed back the detection result to the user.

To improve operability, the motion information output apparatus 1100 can form a virtual image from an image or image information using the image forming plate 1103 and display the virtual image upward and forward of the housing 1101. The image forming plate 1103 is a member having transmissive deflection characteristics for rays, and can be implemented by a multilayer reflecting structure.

Since the motion information output apparatus 1100 includes the displacement measurement device 200, internal scattered light included in reflected light from the object S (the finger of the user) can be eliminated, and hence the displacement measurement device 200 can reliably acquire a very small movement of the non-contact operation of the object S at high speed, and can detect the non-contact operation of the object S with high accuracy.

### Seventh Embodiment

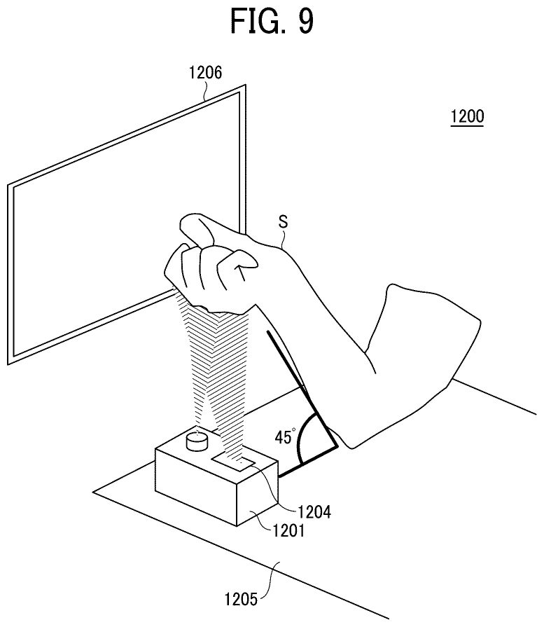

Next, a motion information output apparatus according to a seventh embodiment of the disclosure is described. FIG. 9 is a schematic perspective view of an example of a motion information output apparatus 1200 according to the seventh embodiment of the disclosure.

As illustrated in FIG. 9, the motion information output apparatus 1200 includes a housing 1201, an optical window 1204, a support 1205, and a display device 1206. The motion information output apparatus 1200 also includes the displacement measurement device 200 in the housing 1201.

The motion information output apparatus 1200 illustrated in FIG. 9 is a device that can detect a subtle vibration (for example, tremor) of a living body serving as an object S. A tremor is an involuntary movement that occurs when muscles contract and relax repeatedly, and is typically trembling of a hand. A tremor can be caused by, for example, stress, anxiety, fatigue, hyperthyroidism, or alcohol withdrawal symptoms. A tremor at rest is one of the major symptoms of Parkinson's disease.

A tremor is measured by myoelectric potential measurement or using an acceleration sensor in related art. Since the motion information output apparatus 1200 includes the displacement measurement device 200, internal scattered light included in reflected light from the object S can be eliminated. Thus, the displacement measurement device 200 can reliably acquire a very small vibration of the object S of a micrometer level at high speed. Hence the tremor can be measured with high accuracy in a non-contact environment.

As illustrated in FIG. 9, the motion information output apparatus 1200 can measure a tremor such that the angle from the elbow to the forearm is 45° with respect to the support 1205 that is horizontal. The motion information output apparatus 1200 irradiates the back of a hand with coherent light from the displacement measurement device 200, and reflected light of the coherent light from the back of the hand is incident on the light receiver 30 included in the displacement measurement device 200 as an interference image via the optical window 1204 and the light guide member 20 included in the displacement measurement device 200.

Accordingly, the processor 150 included in the displacement measurement device 200 can reliably detect a very small displacement of the object S at high speed, that is, can measure the tremor of the object S with high accuracy. Tremor data measured by the displacement measurement device 200 is subjected to frequency analysis or the like, and hence can be used for understanding the condition of the user and for medical data.

The application of the displacement measurement device 200 is not limited to the application to the motion information output apparatus 1100 and the motion information output apparatus 1200. The displacement measurement device 200 is applicable to another device or apparatus that measures a displacement of an object S.

For example, the displacement measurement device 200 is applicable to an input device (for example, mouse) including the displacement measurement device 200 and a transmitter that transmits a displacement of an object S estimated by a measurement-object displacement estimator included in the displacement measurement device 200 to an external device to be controlled. Accordingly, the input device can be downsized, and the input device can detect a very small displacement of the object S with high accuracy, thereby, for example, providing a compact and portable input device.

For another example, the displacement measurement device 200 is applicable to a vibration monitoring apparatus in which a display visualizes and displays a temporal variation in a displacement of an object S. Accordingly, the vibration monitoring apparatus can be downsized, and the vibration monitoring apparatus can detect a very small displacement of the object S with high accuracy, thereby providing, for example, a compact and portable (or wearable) vibration monitoring apparatus.

Although the desirable embodiments have been described in detail, the disclosure is not limited to the above-described embodiments, and various modifications and substitutions can be made on the embodiments without departing from the scope of the disclosure as set forth in the appended claims.

For example, the arrangement of the light source 10, the light guide member 20, and the object S may be modified in various ways other than the arrangement of the light source 10, the light guide member 20, and the object S according to any one of the first embodiment to the fourth embodiment. For example, the light source 10 may be disposed above the object S, and the light guide member 20 may be disposed below the object S. The light guide member 20 can allow the light L0 irradiated from the light source 10 to be transmitted through the inside of the object S such as a living body, allow a portion of the scattered light L5 to be incident on the light guide member 20 through the light incident portion 21, guide the light L1 in the light guide member 20, and then emit the light L1 through the light emitting portion 22. The displacement information output device according to any one of the embodiments may include, in addition to the light source 10, the light guide member 20, and the light receiver 30, various members such as a lens and a mirror, or various electronic components in accordance with an object whose information relating to a three-dimensional displacement is acquired. The object S is not limited to a finger of the user, and may be any of various movable bodies.

### Eighth Embodiment

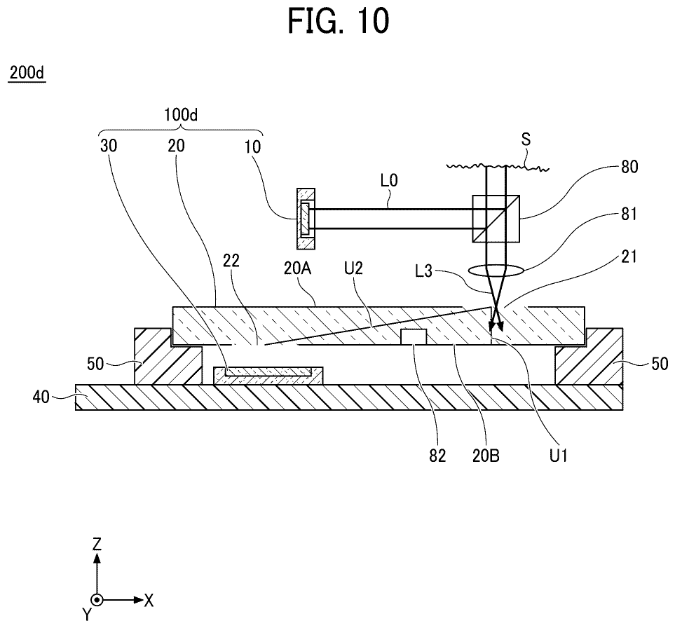

FIG. 10 is a cross-sectional view of a displacement measurement device 200d according to an eighth embodiment of the disclosure.

FIG. 10 is a cross-sectional view taken along II-II in FIG. 1.

The present embodiment differs from the displacement measurement device 200 according to the first embodiment in that the light guide member 20 includes a shield portion 82 that intersects a virtual plane containing a line segment U2 and a line segment along the optical-axis direction U1 of light L3 incident from the light incident portion 21. The line segment connects the light incident portion 21 and the light emitting portion 22. The virtual plane containing the line segment U2 and the line segment indicating the optical-axis direction U1 is a virtual plane parallel to the XZ plane in FIG. 10. The line segment U2 connecting the light incident portion 21 and the light emitting portion 22 is, for example, a line segment connecting the center of the light incident portion 21 and the center of the light emitting portion 22.

In FIG. 10, the displacement measurement device 200d includes a displacement information output device 100d, a beam splitter 80 that reflects part of the light L0 from the light sources 10 toward the object S and transmits the light L3 from the object S, and a lens 81 that focuses the light L3 transmitted through the beam splitter 80. The displacement information output device 100d includes a light source 10, a light guide member 20, and a light receiver 30. The beam splitter 80 transmits the light L3 reflected by the beam splitter 80 and reflected or scattered by the object S. The light L3 focused by a lens 81 passes through the light incident portion 21 and enters the light guide member 20. From another perspective, the light L3 is coupled to the light guide member 20 through the light incident portion 21.

The shield portion 82 has a light-shielding property with respect to the light L3. For example, the light-shielding property of the shield portion 82 is preferably such that the transmittance of the light L3 is 20% or less. The shield portion 82 may be either a reflector or an absorber.

The lens 81 selectively couples, from the light L3 reflected or scattered by the object S, the light that is scattered in the optical-axis direction U1 to the light guide member 20. This configuration reduces the influence of stray light caused by interface reflection of the beam splitter 80 and the shadowed regions in the light incident portion 21, allowing the a light receiver 30 to obtain a speckle pattern (or a speckle image) with a wide and isotropic spatial distribution. In the present embodiment, by improving the spatial distribution of the speckle image, the speckle shift caused by the movement of the object S is quantified with high accuracy, and the measurement accuracy of the displacement measurement device 200d is increased.

The placement of the shield portion 82 reduces the amount of direct light traveling from the light incident portion 21 to the light emitting portion 22. This light is reflected by an upper surface 20A and a lower surface 20B of the internal space of the light guide member 20, without reflecting off the sidewall surfaces (along the Z direction) of the internal space of the light guide member 20.

This facilitates formation of a speckle image having an isotropic shape.

### Simulation Results of Path of Rays and Speckle Image in Light Guide Member 20

In FIG. 10, the light L3 coupled into the light guide member 20 through the light incident portion 21 repeatedly reflects off the upper surface 20A and the lower surface 20B of the light guide member 20 and the linear portion and the curved portion of the sidewall surface in the top view before reaching the light emitting portion 22.

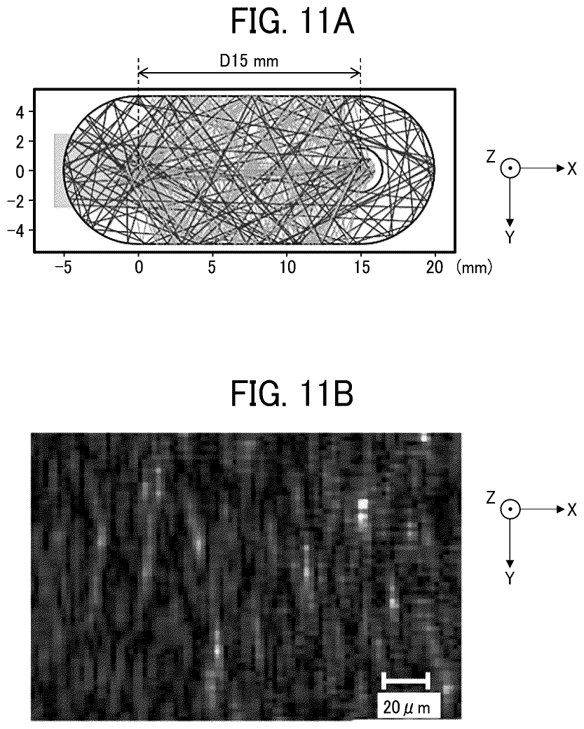

FIGS. 11A and 11B are diagrams each illustrating a first example of the path of rays and a speckle image by simulation.

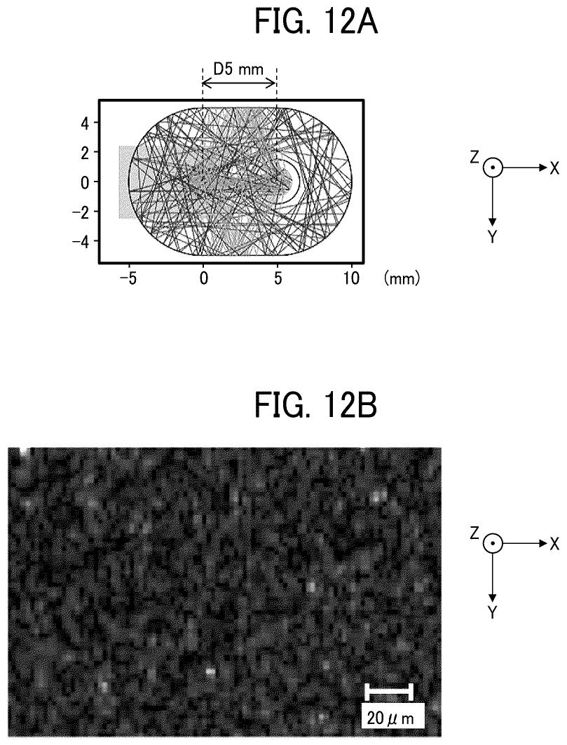

FIGS. 12A and 12B are diagrams each illustrating a second example of the path of rays and a speckle image by simulation.

In FIGS. 11 and 12, the thick solid lines and the thin solid lines represent light rays. The light rays indicated by the thick solid lines represent a group of rays that are reflected by the curved sidewall surface of the light guide member 20.

It is known that the light rays in this group exhibit nonlinearity (or chaotic behavior) through repeated reflections off the curved and straight portions of the sidewall surface of the light guide member 20. Nonlinearity refers to the phenomenon where the light rays do not converge along a specific path of rays but instead, spread throughout the reflective light guide member, resulting in extended propagation paths.

The two types of thin solid lines represent rays of light: one that reaches the light emitting portion 22 directly from the light incident portion 21 without reflecting off a sidewall surface, and another that reaches the light emitting portion 22 after reflecting only on the straight portion of the sidewall in top view. Since these rays do not exhibit non-linearity, the lack of non-linearity becomes a factor that reduces the accuracy of estimating the displacement amount for the object S when estimating the displacement amount for the object S based on changes in the speckle image.

FIGS. 11A and 11B each illustrate the light ray paths and the speckle image in the light guide member 20. The straight portion of the light guide member 20 extends in the C direction and has a length D of 15 mm. FIGS. 12A and 12B illustrate the light ray paths and the speckle image in the light guide member 20. The straight portion of the light guide member 20 extends in the C direction and has a length D of 5 mm. In FIGS. 11A and 12A, the top section presents the light ray paths, and the bottom section presents the speckle image calculated from the optical path length distribution of the rays.

In FIGS. 11A, 11B, 12A, and 12B, it can be seen that FIGS. 12A and 12B have a higher proportion of rays that have reflected off the curved portions of the sidewalls in the top view, resulting in the formation of a speckle image with an isotropic shape.

### Modification

The following describes various modifications of the light guide member 20.

### First Modification to Fourth Modification

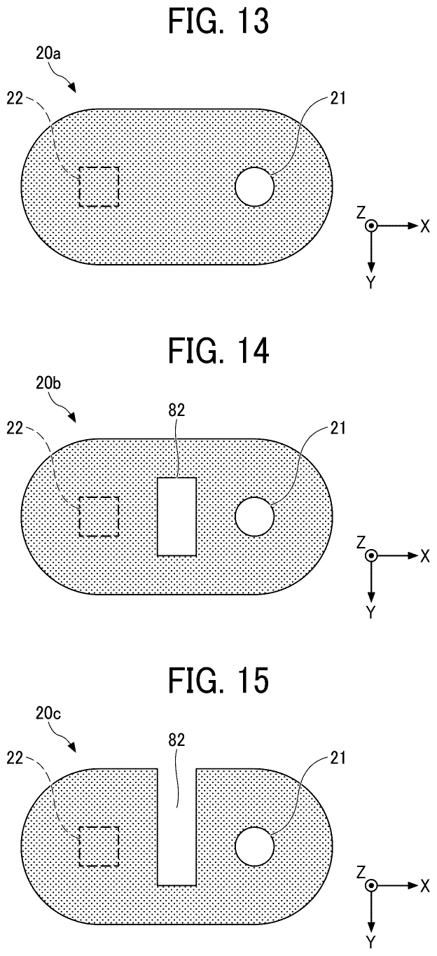

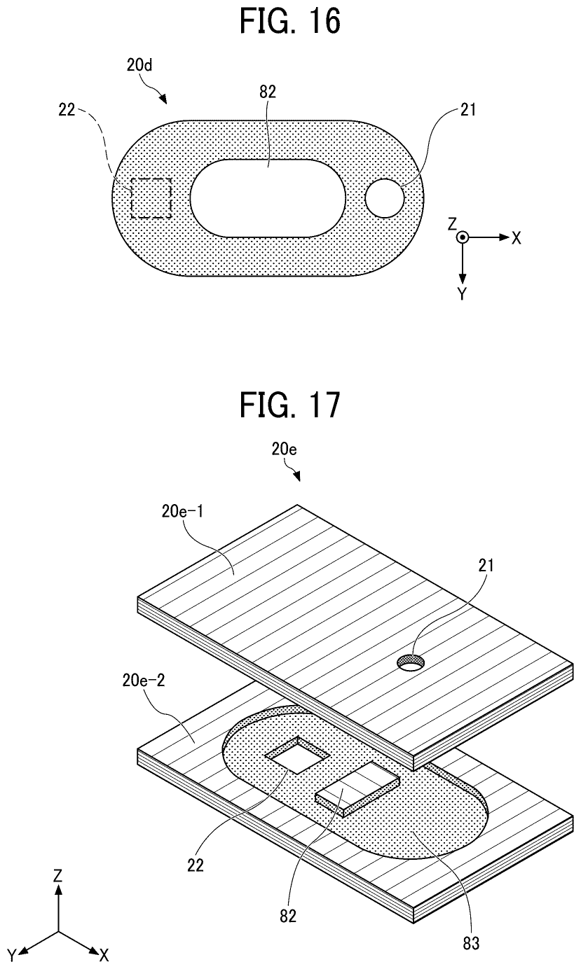

FIG. 13 is a schematic top view of a light guide member 20a according to a first modification. FIG. 14 is a schematic top view of a light guide member 20b according to a second modification. FIG. 15 is a schematic top view of a light guide member 20c according to a third modification. FIG. 16 is a schematic top view of a light guide member 20d according to a fourth modification. Each of the light guide member 20a, the light guide member 20b, the light guide member 20c, and the light guide member 20d includes a light incident portion 21 and a light emitting portion 22.

The light guide member 20a in FIG. 13 has a stadium shape in top view. The light guided in the light guide member 20a includes not only the light reflected off the curved portions of the sidewalls in the top view, as described in FIGS. 11A, 11B, 12A, and 12B, but also the light reflected from the straight portions of the sidewalls in the top view, as well as from the upper surface 20A and the lower surface 20B

The light guide member 20b in FIG. 14 includes a substantially rectangular shield portion 82 in its center portion in the top view. The shield portion 82 in light guide member 20b blocks more light that avoids reflecting off the curved sidewalls than the light guide member 20a does.

The light guide member 20c in FIG. 15 includes a shield portion 82 having a substantially rectangular shape in the top view. However, the shield portion 82 in light guide member 20c is offset in the-Y-direction compared to the light guide member 20b. In the light guide member 20c, a part of the outer perimeter of the light guide member 20c and a part of the shield portion 82 are common. Since a part of the outer perimeter of the light guide member 20c and a part of the shield portion 82 are common, the manufacturing difficulty of the light guide member 20c is reduced.

The light guide member 20d in FIG. 16 includes a stadium-shaped shield portion 82 in its central portion when viewed from above (or in the top view). The light guide member 20d blocks direct light by the shield portion 82. The shield portion 82 of the light guide member 20d includes a curved portion in its outer shape in the top view. The shield portion 82 includes the curved portion in the top view, and thus the light returning to the light incident portion 21 is reduced. The curved portion of the shield portion 82 serves as a sidewall surface. This enhances the light diffusion effect caused by the nonlinearity in the light guide member 20d.

### Fifth Modification and Sixth Modification

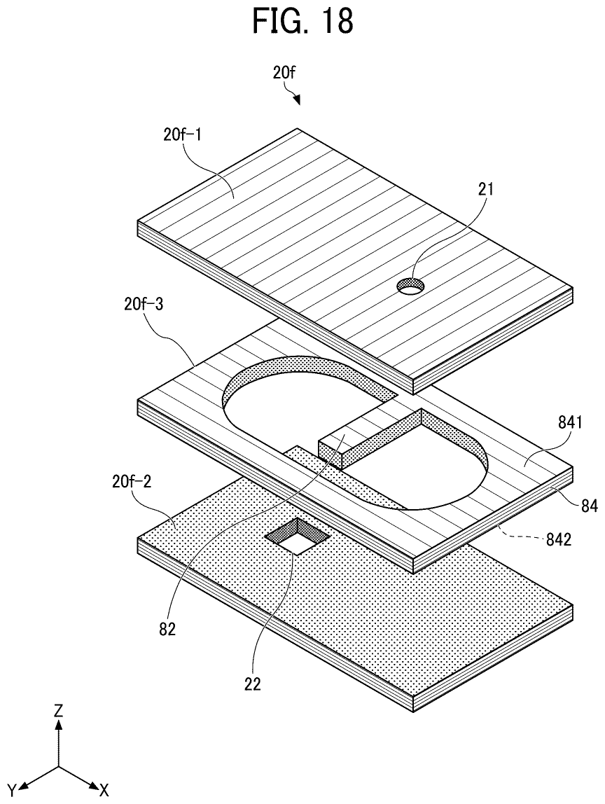

FIG. 17 is a schematic exploded perspective view of a light guide member 20e according to a fifth modification. FIG. 18 is a schematic exploded perspective view of a light guide member 20f according to a sixth modification.

The light guide member 20e and the light guide member 20f differ from the light guide member 20 of the displacement information output device 100 according to the first embodiment in that the light guide member 20e and the light guide member 20f include portions with curvature in the inner wall forming the internal space.

By including portions with curvature in the inner wall that forms the internal space, the amount of light reflected from the curved portions increases as the light travels from the light incident portion 21 to the light emitting portion 22, making it easier to form an isotropic speckle image.

In FIG. 17, the light guide member 20e includes a first substrate 20e-1 including the light incident portion 21 and a second substrate 20e-2 including the light emitting portion 22, the shield portion 82, and a recessed portion 83. The surfaces of the non-contact faces of the first substrate 20e-1 and the second substrate 20e-2 are mirror-finished. The first substrate 20e-1 and the second substrate 20e-2 are bonded without gaps using substrate bonding methods such as adhesive or anodic bonding, or by methods such as screw fastening.

The light emitting portion 22 is a through-hole formed in the recessed portion 83. The shield portion 82 is a convex portion formed in the recessed portion 83. When the first substrate 20e-1 and the second substrate 20e-2 are joined, the recessed portion 83 becomes an internal space formed inside the light guide member 20e. The light entering the light guide member 20e from the light incident portion 21 is confined within the internal space, totally reflected by the internal wall surfaces defining the internal space, and guided through the light guide member 20e. The light guide member 20e formed by joining the first substrate 20e-1 and the second substrate 20e-2 efficiently confines light inside the light guide member 20e due to the absence of gaps between the first substrate 20e-1 and the second substrate 20e-2.

In FIG. 18, the light guide member 20f includes a first substrate 20f-1 including the light incident portion 21, a second substrate 20f-2 including the light emitting portion 22, and a third substrate 20f-3 disposed between the first substrate 20f-1 and the second substrate 20f-2 and including the shield portion 82.

The third substrate 20f-3 includes an outer peripheral portion 84 that supports the shield portion 82. The outer peripheral portion 84 is disposed around the shield portion 82, with its part connected to the shield portion 82 to support the shield portion 82. The inner side of the outer peripheral portion 84 as seen from above (or in the top view) penetrates from the upper surface 841 to the lower surface 842 of the third substrate 20f-3, except for the area where the shield portion 82 is located. This through-structure facilitate the positioning and operation of mirror-finishing tools, such as polishing tolls, when applying a mirror finish to the first substrate 20f-1, the second substrate 20f-2, and the third substrate 20f-3. As a result, it becomes easier to manufacture the light guide member 20f with high surface precision.

A mirror finish is applied to the surfaces of the first substrate 20f-1 and the second substrate 20f-2 that define the internal space of the light guide member 20f. Since the surfaces of the first substrate 20f-1 and the second substrate 20f-2 that define the internal space of the light guide member 20f are flat, the positioning and operation of mirror-finished tools, such as polishing tools becomes easier. Thus, it becomes easier to manufacture the light guide member 20f with high surface precision. The bonding method for the first substrate 20f-1, the second substrate 20f-2, and the third substrate 20f-3 may include adhesive bonding, anodic bonding, or methods such as screw fastening.

### Seventh Modification to Ninth Modification

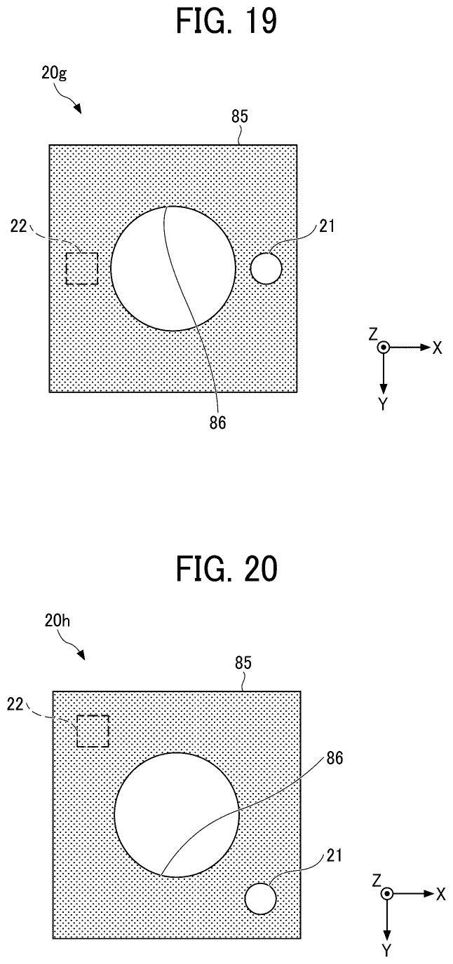

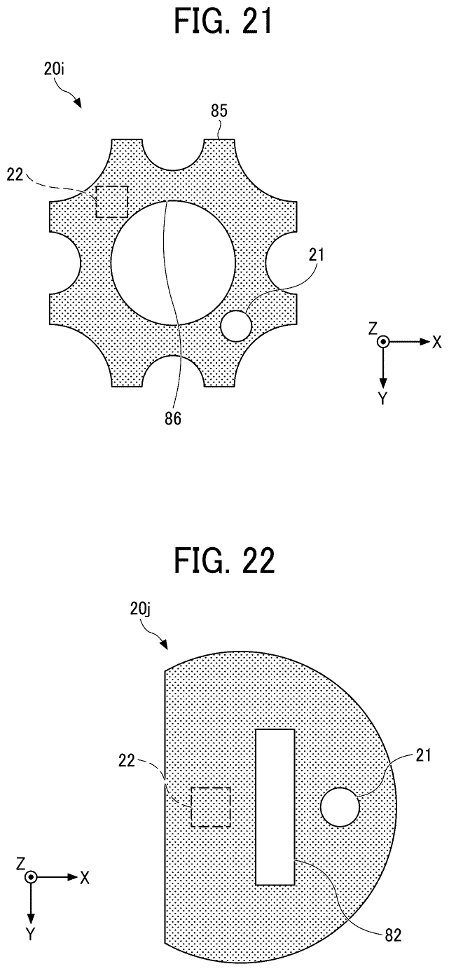

FIG. 19 is a schematic top view of a light guide member 20g according to a seventh modification. FIG. 20 is a schematic top view of a light guide member 20h according to an eighth modification. FIG. 21 is a schematic top view of a light guide member 20i according to a ninth modification.

The light guide member 20g, the light guide member 20h, and the light guide member 20i have a structure that is the inverse of the stadium-shaped structure when viewed from above, meaning an outer wall 85 includes a straight portion and an inner wall 86 includes a curved portion. Such a structure is called a Sinai-shaped structure. Shinai-structures are known to exhibit nonlinearity or chaotic behavior.

In FIGS. 19 to 21, the light guide member 20g, the light guide member 20h, and the light guide member 20i, which are Shinai-shaped, each incudes a light incident portion 21 and a light emitting portion 22. The light guide member 20g, the light guide member 20h, and the light guide member 20i each has an inner peripheral wall 86 with a substantially circular shape in the top view. In the light guide member 20g, the light guide member 20h, and the light guide member 20i, the number of light rays reflected by the inner peripheral wall 86 can be increased, and components reflected only by the outer wall 85 can be reduced.

The light guide member 20g in FIG. 19 has a substantially rectangular outer shape in the top view. The light incident portion 21 and the light emitting portion 22 are arranged side by side in the X direction along the edges of the outer shape of the light guide member 20g. In the light guide 20g, the short distance between the light incident portion 21 and the light emitting portion 22 allows for the miniaturization of the light guide member 20g, downsizing the displacement measurement device that incorporates the light guide member 20g.

The light guide member 20h in FIG. 20 has a substantially rectangular outer shape in the top view. The light incident portion 21 and the light emitting portion 22 are arranged along the diagonal direction of the outer shape of the light guide member 20g. The light guide member 20h has sufficient space to position the light incident portion 21 and the light emitting portion 22. This facilitates the manufacturing of the light guide member 20h. Furthermore, the increased size of the inner peripheral wall 86 allows the group of light rays reflected by the inner peripheral wall 86 to be more efficiently guided to the light emitting portion 22

The light guide member 20i in FIG. 21 has an outer shape that includes curved portions at the corners and the central portion of the edges of its substantially rectangular shape. In FIG. 21, the curvature of the curved portions at the corners is different from the curvature of the curved portion at the central portion of the edges. However, the curvature of the curved portions at the corners may be the same as the curvature of the curved portion at the central portion of the edges. In the light guide member 20i, the width of the path of rays guided is narrow, resulting in an increased number of reflections along the path from the light incident portion 21 to the light emitting portion 22. With an increased number of reflections, light can be mixed and a variety of optical path lengths can be achieved.

### Tenth Modification to Twelfth Modification

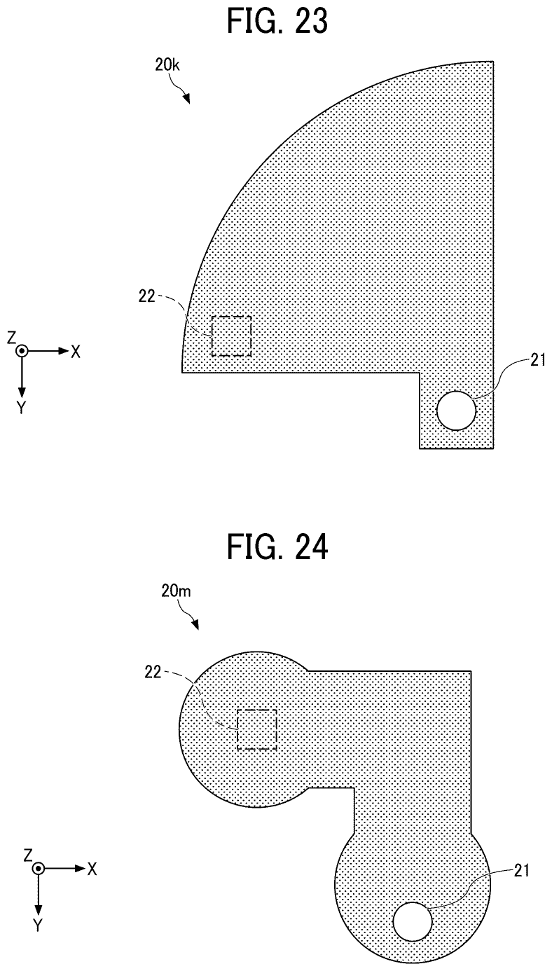

FIG. 22 is a schematic top view of a light guide member 20j according to a tenth modification. FIG. 23 is a schematic top view of a light guide member 20k according to an eleventh modification. FIG. 24 is a schematic top view of a light guide member 20m according to a twelfth modification.

The light guide member 20j, the light guide member 20k, and the light guide member 20m each include a linear portion and a curved portion in a top view. In the light guide member 20j, the light guide member 20k, and the light guide member 20m, the light entering through the light incident portion 21 is reflected by the outer peripheral wall corresponding to the curved portion in the top view, before reaching the light emitting portion 22.

The light guide member 20j in FIG. 22 has a substantially D-shaped outline in a top view. The light guide member 20j includes a substantially rectangular shield portion 82 between a light incident portion 21 and a light emitting portion 22. The shield portion 82 of the light guide member 20j prevents light that is not reflected by the outer peripheral wall corresponding to the curved portion in the top view, from reaching the light emitting portion 22. Further, by placing the light incident portion 21 adjacent to the outer peripheral wall corresponding to the curved portion in the top view, most of the incoming light is reflected, allowing the light to be guided to the light emitting portion 22 as nonlinear light.

The light guide member 20k in FIG. 23 has a substantially sector-shaped outline with a central angle of 90 degrees in the top view. The light incident portion 21 is located in a region protruding from the substantially central portion of the substantially sector shape in a top view. The light emitting portion 22 is located near the arc of the substantially fan-shaped sector. With the light incident portion 21 located in a region protruding from the substantially central portion of the substantially fan-shaped sector, the incidence of direct light is reduced. The light reaching the light emitting portion 22 is reflected once by the outer peripheral wall. In the light guide member 20k, the outer peripheral wall serves the same function as the shield portion 82 in light guide members, such as the light guide member 20j. Since the outer peripheral wall has the same function as the function of the shield portion 82, the manufacturing of the light guide member 20k becomes easier compared to light guide members, such as the light guide member 20j.

The light guide member 20m in FIG. 24 has a substantially L-shaped outline including a 90-degree bend as viewed from the top. The light guide member 20m, when viewed from the top, includes curved portions at each of two ends of the substantially L-shaped outline. The light incident portion 21 is positioned at one of the two ends of the substantially L-shaped form when viewed from above. The light emitting portion 22 is positioned at the other of the two ends of the substantially L-shaped form when viewed from above. Since the light guide member 20m has a substantially L-shaped form when viewed from above, the light entering from the light incident portion 21 reflects off the outer peripheral wall before reaching the light emitting portion 22. By adjusting the width of the area where the straight portion of the substantially L-shaped form extends when viewed from above, the number of light reflections, or the distribution of the light path lengths, can be controlled. In the top view, the curved portion where the light incident portion 21 is disposed forms a part of a circle. The light incident portion 21 is positioned off-center from the center of the circle. As a result, compared to positioning the light incident portion 21 at the center of the circle, the likelihood of light entering through the light incident portion 21 being reflected by the outer peripheral wall corresponding to the curved portion from viewed from above and returning to the light incident portion 21, then exiting through the light incident portion 21, is reduced As a result, the light use efficiency is increased.

### Thirteenth Modification to Fifteenth Modification

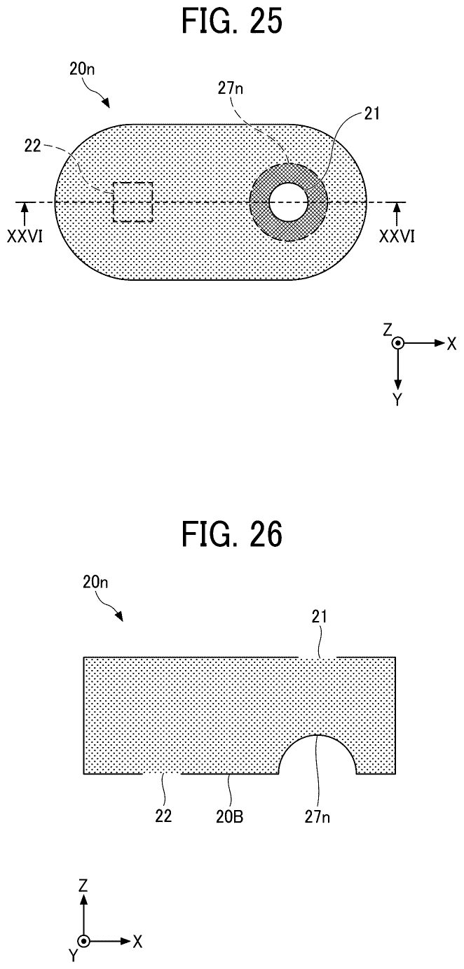

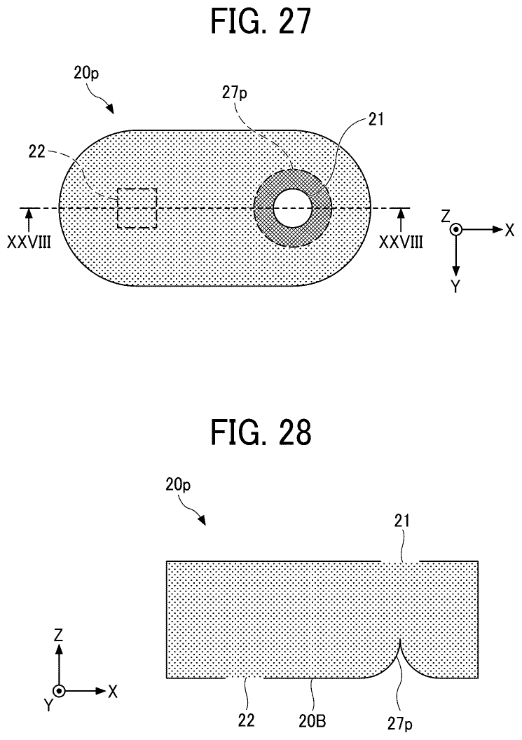

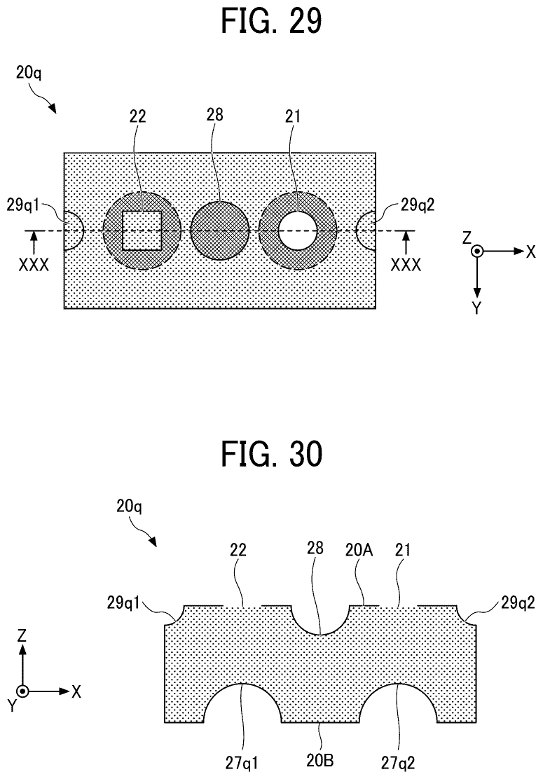

FIG. 25 is a schematic top view of a light guide member 20n according to a thirteenth modification. FIG. 26 is a schematic cross-sectional view taken along line XXVI-XXVI in FIG. 25. FIG. 27 is a schematic top view of a light guide member 20p according to a fourteenth modification. FIG. 28 is a schematic cross-sectional view taken along line XXVIII-XXIIVI in FIG. 27. FIG. 29 is a schematic top view of a light guide member 20q according to a fifteenth modification. FIG. 30 is a schematic cross-sectional view taken along the line XXX-XXX in FIG. 29.

The light guide member 20n, the light guide member 20p, and the light guide member 20q differ from the light guide member 20 of the displacement information output device 100 according to the first embodiment in that at least one of an upper surface and a lower surface of each of the light guide member 20n, the light guide member 20p, and the light guide member 20q has a recess. As a result, as described below, the light guide member 20n, the light guide member 20p, and the light guide member 20q can increase the light path diffusion in each of the respective light guide members.

The light guide member 20n in FIG. 25 has a stadium shape in top view. As illustrated in FIG. 26, the light guide member 20n includes a first recessed portion 27n in a lower surface 20B. In FIG. 26, the first recessed portion 27n is a hemispherical recess. The first recessed portion 27n is located directly below the light incident portion 21. The first recessed portion 27n included in the light guide member 20n causes the light coupled to the light guide member 20n through the light incident portion 21, to be reflected in various directions. The light reaching the light emitting portion 22 is diffused by nonlinearity and then emitted from the light emitting portion 22. As a result, the diffusion effect of the light emitted from the light emitting unit 22 is enhanced. Further, since the light guide member 20n includes the hemispherical first recessed portion 27n, the manufacturing of the light guide member 20n is easier than in a recessed portion with sharp or pointed features.

The light guide member 20p in FIG. 27 has a stadium shape in top view. As illustrated in FIG. 28, the light guide member 20p includes a second recessed portion 27p in a lower surface 20B. In FIG. 28, the second recessed portion 27p includes a pointed portion. The second recessed portion 27p is located directly below the light incident portion 21. The second recessed portion 27p included in the light guide member 20p causes the light coupled to the light guide member 20p through the light incident portion 21, to be reflected in various directions. The light reaching the light emitting portion 22 is diffused by nonlinearity and then emitted from the light emitting portion 22. As a result, the diffusion effect of the light emitted from the light emitting unit 22 is enhanced. Moreover, since the light guide member 20p in the light guide member 20p includes pointed features, its light coupling efficiency is higher than that of the hemispherical light guide member 20n.

The light guide member 20q in FIG. 29 has a substantially rectangular outer shape in the top view. In the light guide member 20q, both the light incident portion 21 and the light emitting portion 22 are disposed on the upper surface 20A. As illustrated in FIG. 30, the light guide member 20q includes a third recessed portion 27q1 and a fourth recessed portion 27q2 in a lower surface 20B. The light guide member 20q includes a fifth recessed portion 28, a sixth recessed portion 29q1, and a seventh recessed portion 29q2 in the upper surface 29q2. In FIG. 30, the third recessed portion 27q1, the fourth recessed portion 27q2, and the fifth recessed portion 28 each include a hemispherical portion. The third recessed portion 27q1 is located directly below the light emitting portion 22. The fourth recessed portion 27q2 is located directly below the light incident portion 21. The fifth recessed portion 28 is located between the light incident portion 21 and the light emitting portion 22. The sixth recessed portion 29q1 is located outside the light emitting portion 22 in the top view. The seventh recessed portion 29q2 is located outside the light incident portion 21 in the top view. The light guide member 20q with third recessed portion 27q1 and the fourth recessed portion 27q2 enhances the mixing of light coupled into the light guide member 20p through the light incident portion 21. As a result, the diffusion effect of the light emitted from the light emitting unit 22 is enhanced. The curvatures of the third recessed portion 27q1, the fourth recessed portion 27q2, the fifth recessed portion 28, the sixth recessed portion 29q1, and the seventh recessed portion 29q2 are partially different. However, the curvatures of the third recessed portion 27q1, the fourth recessed portion 27q2, the fifth recessed portion 28, the sixth recessed portion 29q1, and the seventh recessed portion 29q2 may either differ from each other or be the same.

Numerals such as ordinal numbers and numerical values used in the description of the embodiments are examples for specifically describing the technology of the disclosure, and the disclosure is not limited by the exemplified numerals. The connection relationship between the components is an example for specifically describing the technology of the disclosure, and the connection relationship that implements the functions of the disclosure is not limited thereto.

The displacement information output device, the displacement measurement device, and the motion information output apparatus according to the embodiments of the disclosure can acquire and output displacement information with high accuracy, and hence can be used for various purposes.

For example, the displacement information output device, the displacement measurement device, and the motion information output apparatus according to the embodiments of the disclosure can be suitably used in a motion capture device mounted on a controller of a displacement electronic apparatus, an operation device in a VR space, an operation device used while a user wears AR glasses, or an operation device of a game apparatus. By using the displacement information output device, the displacement measurement device, and the motion information output apparatus according to the embodiments of the disclosure, a natural operation input can be provided in a non-contact manner without restricting the movement of the user.

The displacement information output device, the displacement measurement device, and the motion information output apparatus according to the embodiments of the disclosure can acquire and output displacement information with high accuracy, and hence can be suitably used as a detector that can detect various objects such as vibration and tremor.

Aspects of the disclosure are, for example, as follows.

According to Aspect 1, a displacement information output device includes: a light source to emit light to an object; a light guide member, and a light receiver. The light guide member includes a light incident portion from which the light subjected to at least one of reflection or scattering from the object is incident; and a light emitting portion from which the light guided through the light guide member is emitted. The light receiver receives the light emitted from the light emitting portion; and outputs information related to a three-dimensional displacement of the object obtained based on the emitted light.

According to Aspect 2, in the displacement information output device according to Aspect 1, the light guide member includes a shield portion that intersects a virtual plane including a line segment connecting the light incident portion and the light emitting portion and a line segment indicating an optical-axis direction of light incident from the light incident portion.

According to Aspect 3, in the displacement information output device according to Aspect 1 or 2, the light guide member has an inner space having a curved inner wall in a part of the inner space.

According to Aspect 4, the displacement information output device according to any one of Aspect 1 to Aspect 3, the light guide member has: an outer wall including a straight portion; and an inner wall including a curved portion, in a top view of the light guide member.

According to Aspect 5, in the displacement information output device according to Aspect 4, the light guide member has a rectangular outer shape as a whole, and the rectangular outer shape having partially curved portions at: corners of the rectangular outer shape; and central portions between the corners of the rectangular outer shape, in the top view of the light guide member.

According to Aspect 6, in the displacement information output device according to any one of Aspect 1 to Aspect 3, the light guide member has at least one of: a D-shaped outer shape; a sector outer shape with a central angle of 90 degrees; or a right-angled shape, in a top view of the light guide member.

According to Aspect 7, in the displacement information output device according to any one of Aspect 1 to Aspect 6, the light guide member includes a recessed portion in at least one of an upper surface or a lower surface of the light guide member.

According to any one of Aspects 8, in the displacement information output device of any one of Aspects 1 to 7, the light emitted from the light emitting portion has speckles generated by the at least one of reflection or scattering from the object, and the light receiver outputs information related to a three-dimensional displacement of the object obtained based on the speckles.

According to Aspect 9, in the displacement information output device of any one of Aspects 1 to 8, the light guide member includes a member long in a predetermined longitudinal direction. The light guide member has a length in a longitudinal direction. The light guide member has end portions on both sides of the light guide member in the longitudinal direction. Each of the end portions has curved surfaces. The light guide member has linear portions disposed between the curved surfaces in the longitudinal direction, and the linear portions extend in the longitudinal direction.

According to Aspect 10, in the displacement information output device of any one of Aspects 1 to 9, the light guide member is disposed between the object and the light source in a light emission direction of the light source to emit light to the object, and the light emitted from the light source irradiates the object through the light guide member.

According to Aspect 11, in the displacement information output device of any one of Aspects 1 to 10, the light source is disposed on a side on which the object is located with respect to the light guide member. The light emitted from the light source irradiates the object through the light guide member.

According to Aspect 12, the displacement information output device of any one of Aspects 1 to 11 further includes a light deflecting member disposed between the object and the light guide member. The light emitted from the light source is incident on the light deflecting member. The light deflecting member irradiates the object with the light incident from the light source. The light guide member guides the light incident from the light incident portion after the light irradiated from the light deflecting member is scattered at the object.

According to Aspect 13, in the displacement information output device of any one of Aspects 1 to 12, the light guide member includes a light reflective member covering a surface of the light guide member. The light incident portion includes a first opening provided in the light reflective member. The light emitting portion includes a second opening provided in the light reflective member.

According to Aspect 148, in the displacement information output device of any one of Aspects 1 to 12, the light guide member totally reflects the light incident from the light incident portion in the light guide member to guide the light.

According to Aspect 15, in the displacement information output device of any one of Aspects 1 to 14, the light guide member includes a laser medium to amplify the light guided in the light guide member.

According to Aspect 16, in the displacement information output device of any one of Aspects 1 to 15, the light receiver includes multiple pixels, detects a change in brightness of each of the multiple pixels, and outputs information relating to the change in the brightness in combination with coordinate information and time information.

According to Aspect 17, in the displacement information output device according to any one of Aspect 1 to Aspect 16, the light guide member is a plate-shaped member.

According to Aspect 18, in the displacement information output device of any one of Aspect 1 to Aspect 16, the light guide member includes a member long in a predetermined longitudinal direction, and includes a rotationally symmetrical body having a rotation axis that is a center axis of the light guide member extending in the longitudinal direction.

According to Aspect 19, in the displacement information output device of any one of Aspects 1 to 16, the light guide member includes a hollow member.

According to Aspect 20, a displacement measurement device includes the displacement information output device of any one of Aspects 1 to 19; and a processor to output a measurement result of a three-dimensional displacement of the object obtained based on the information relating to the three-dimensional displacement input from the displacement information output device.

According to Aspect 21, a motion information output apparatus includes the displacement measurement device of Aspect 20. The motion information output apparatus outputs motion information on the object obtained based on the measurement result of the three-dimensional displacement of the object input from the displacement measurement device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A displacement information output device comprising:
a light source to emit light to an object;
a light guide member including:
a light incident portion from which the light subjected to at least one of reflection or scattering from the object is incident; and
a light emitting portion from which the light guided through the light guide member is emitted; and
a light receiver to:
receive the light emitted from the light emitting portion; and
output information related to a three-dimensional displacement of the object obtained based on the emitted light.

2. The displacement information output device according to claim 1, further comprising a shield portion positioned to block a portion of the light from the light incident portion to the light emitting portion.

3. The displacement information output device according to claim 1,
wherein the light guide member has an inner space having a curved inner wall in a part of the inner space.

4. The displacement information output device according to claim 1,
wherein the light guide member has:
an outer wall including a straight portion; and
an inner wall including a curved portion,
in a top view of the light guide member.

5. The displacement information output device according to claim 4,
wherein the light guide member has a rectangular outer shape as a whole, and
the rectangular outer shape having partially curved portions at:
corners of the rectangular outer shape; and
central portions between the corners of the rectangular outer shape,
in the top view of the light guide member.

6. The displacement information output device according to claim 1,
wherein the light guide member has at least one of:
a D-shaped outline;
a sector-shaped outline with a central angle of 90 degrees; or
an L-shaped outline including a 90-degree bend,
in a plane orthogonal to a vertical direction.

7. The displacement information output device according to claim 1,
wherein the light guide member has a recessed portion at least one of an upper surface or a lower surface of the light guide member.

8. The displacement information output device according to claim 1,
wherein the light emitted from the light emitting portion has speckles generated by the at least one of reflection or scattering from the object, and
the light receiver outputs information related to a three-dimensional displacement of the object obtained based on the speckles.

9. The displacement information output device according to claim 1,
wherein the light guide member has a length in a longitudinal direction,
the light guide member has end portions on both sides of the light guide member in the longitudinal direction,
each of the end portions has curved surfaces,
the light guide member has linear portions disposed between the curved surfaces in the longitudinal direction, and
the linear portions extend in the longitudinal direction.

10. The displacement information output device according to claim 1,
wherein the light guide member is disposed between the object and the light source in a light emission direction of the light source to emit light to the object, and
the light emitted from the light source irradiates the object through the light guide member.

11. The displacement information output device according to claim 1,
wherein the light source is on a side on which the object is located with respect to the light guide member, and
the light emitted from the light source irradiates the object without passing through the light guide member.

12. The displacement information output device according to claim 1, further comprising a light deflector between the object and the light guide member,
wherein the light emitted from the light source is incident on the light deflector,
the light deflector irradiates the object with the light incident from the light source, and
the light guide member guides the light incident from the light incident portion after the light irradiated from the light deflector is scattered at the object.

13. The displacement information output device according to claim 1,
wherein the light guide member includes a light reflective member covering a surface of the light guide member,
the light incident portion includes:
a first opening in the light reflective member, and
a second opening in the light reflective member.

14. The displacement information output device according to claim 1,
wherein the light guide member totally reflects the light incident from the light incident portion in the light guide member to guide the light.

15. The displacement information output device according to claim 1,
wherein the light guide member includes a laser medium to amplify the light guided in the light guide member.

16. The displacement information output device according to claim 1,
wherein the light receiver includes multiple pixels, detects a change in brightness of each of the multiple pixels, and outputs information relating to the change in the brightness in combination with coordinate information and time information.

17. The displacement information output device according to claim 1,
wherein the light guide member includes a member long in a longitudinal direction, and includes a rotationally symmetrical body having a rotation axis that is a center axis of the light guide member extending in the longitudinal direction.

18. The displacement information output device according to claim 2,
wherein the shield portion intersects a virtual plane including:
a first line segment connecting the light incident portion and the light emitting portion; and
a second line segment parallel to an optical-axis direction of the light incident from the light incident portion.

19. A displacement measurement device comprising:
the displacement information output device according to claim 1; and
circuitry configured to output a measurement result of a three-dimensional displacement of the object obtained based on the information relating to the three-dimensional displacement input from the displacement information output device.

20. A motion information output apparatus comprising the displacement measurement device according to claim 19,
wherein the motion information output apparatus outputs motion information on the object obtained based on the measurement result of the three-dimensional displacement of the object input from the displacement measurement device.
